(19) United States
(12) Patent Application Publication
(10) Pub. No.: US 2007/0235500 A1
(43) Pub. Date: Oct. 11, 2007

(54) ROOM TEMPERATURE JOINING PROCESS WITH PIEZOELECTRIC CERAMIC-ACTIVATED REACTIVE MULTILAYER FOIL

(76) Inventors: Daewoong Suh, Phoenix, AZ (US); Yongki Min, Phoenix, AZ (US)

Correspondence Address: SCHWEGMAN, LUNDBERG & WOESSNER, P.A., P.O. BOX 2938, MINNEAPOLIS, MN, 55402, US

(21) Appl. No.: 11/278,365

(22) Filed: Mar. 31, 2006

(51) Int. Cl. A47J 36/02

(52) U.S. Cl. 228/101

(57) ABSTRACT

Apparatus comprising a multilayered reactive foil preform including alternating layers of first and second materials deposited on foils. The layers also include piezoelectric ceramic particles to provide an electrical stimulus when pressure is applied to activate an exothermic reaction between the first and second materials.

### BACKGROUND

Typical industry practice is to interconnect electronic devices with a metallurgical bond that uses solder. The conventional solder of eutectic tin-lead (Sn/Pb) and most lead-free solders (E.g. tin-gold-copper (Sn/Au/Cu)) have melting points of 183° C. to 217° C. and above. These melting temperatures, and consequently reflow temperatures, often impose thermal stress on electronic components. The thermal stress is due to a mismatch of thermal expansion among components and may result in device failure. Moreover, the high reflow temperatures can make the use of solder incompatible with heat-sensitive devices such as polymer memory and optoelectronic devices that require assembly at low temperatures such as 80° C. to 125° C. However, a typical operating temperature of such devices is 60° C. to 80° C. This makes it possible for the operating temperature range of a device to overlap the solder reflow temperature range, which results in device failure. Temperature sensitivity of devices may preclude use of metallurgical bonding and prevent the use of such devices when designing electronic systems.

Some low temperature solders are being developed, but the melting temperature of such solder typically approaches ninety to ninety-five percent of the operating temperature of such devices. This can pose a reliability risk for electronic assemblies; especially when devices are subject to reliability testing, such as temperature cycling and device baking for example.

Conductive adhesives for bonding electronic devices are also being developed. Some challenges to the development of the adhesives include poor electric performance due to water absorption and oxygen permeation, low impact strength due to high filler content of the adhesives, poor adhesion to copper-tin finished pads, and poor long-term reliability of the resulting bond.

### BRIEF DESCRIPTION OF THE DRAWINGS

FIG. 1 illustrates a representation of a multilayer reactive foil.

FIG. 2 is an illustration of sheets of piezoceramic material.

FIG. 3 is a diagram of a piezoceramic sheet reduced to a simplified cubic shape.

FIG. 4 illustrates portions of an embodiment of an electronic assembly.

FIG. 5 illustrates a representation of an embodiment of an apparatus that includes a multilayered reactive foil preform.

FIG. 6 illustrates a representation of another embodiment of an apparatus that includes a multilayered reactive foil preform.

FIG. 7 illustrates portions of another embodiment of an electronic assembly.

FIG. 8 is a block diagram representing a manufacturing process to make multilayered reactive foil preforms.

FIG. 9 is a block diagram of an electronic system.

FIG. 10 is a block diagram of a method that provides low-temperature metallurgical bonding.

### DETAILED DESCRIPTION

In the following detailed description, reference is made to the accompanying drawings which form a part hereof, and in which is shown by way of illustration specific embodiments in which the invention may be practiced. It is to be understood that other embodiments may be used and structural and logical changes may be made without departing from the scope of the present invention.

This document describes systems and methods to provide low-temperature metallurgical bonding for interconnecting electronic components. Low-temperature bonding is possible if the heat involved in making the metallurgical bond is localized to a small area to prevent damage to temperature sensitive electronic components.

Self-propagating exothermic reactions in multilayer reactive foils have been developed. Multilayer reactive foils consist of sets of alternate layers of materials that release a high amount exothermic heat in a chemical reaction when combined. An illustrative example includes alternate layers of aluminum (Al) and nickel (Ni). The individual layers (of Al or Ni) of the foils are only nanometers thick, but hundreds of these layers can be sputter-deposited to form one multilayer foil having a total thickness between 10 and 100 microns. Materials that can be used in self-propagating reactions in nano-structured multi-layer foils include aluminum-nickel (Al/Ni), aluminum-zirconium (Al/Zr), nickel-silicon (Ni/Si), and niobium-silicon (Nb/Si).

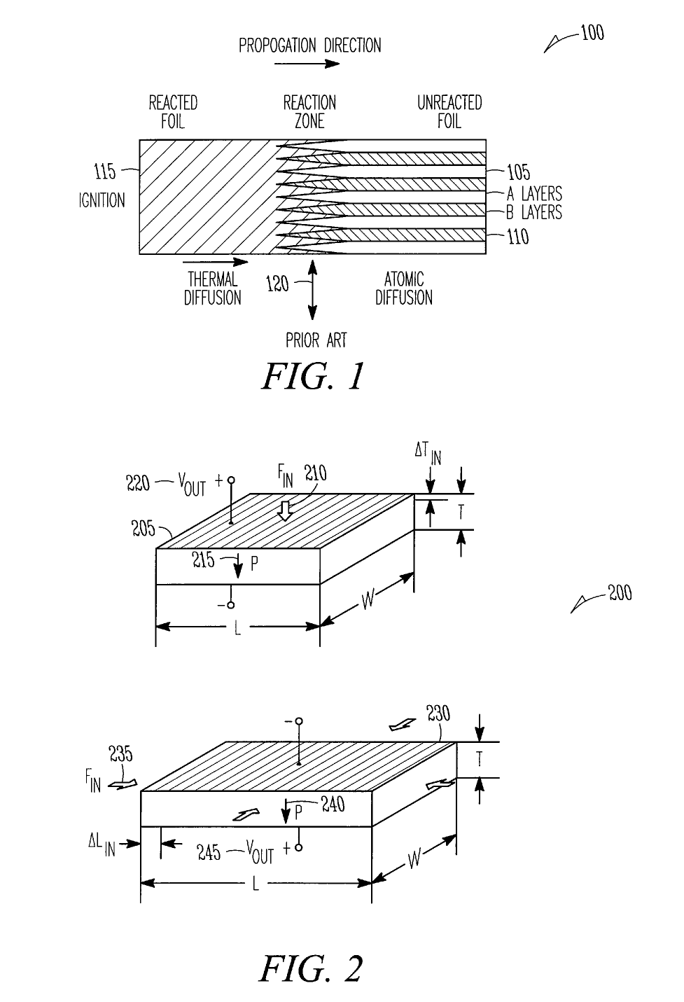

FIG. 1 illustrates a representation of a multilayer reactive foil 100. The foil is made of layers of compound A 105 alternating with layers of compound B 110. The self-propagating reaction in the foils is driven by a reduction in chemical bond energy when the two compounds are combined. When a small thermal pulse is provided at an ignition point 115 to begin the exothermic reaction, atoms diffuse in a direction 120 normal to the foil layers 105, 110, and bonds between A molecules (A-A) and B molecules (B-B) release energy as A-B molecules are formed. This bond exchange produces a large amount of exothermic heat. The heat causes the reaction to self-propagate, and the reaction is conducted down the foil away from the ignition point 115. As the atoms in the compounds combine, heat is released rapidly. The exothermic reactions propagate at speeds greater than ten meters per second (10 m/s) and they can reach temperatures above 1200° C. in milliseconds. The reactions can propagate in air, vacuum, or liquids.

The self-propagating exothermic reactions in these foils provide rapid bursts of energy at room temperature that can heat and melt a surrounding layer of solder or provide heat to braze layers and join two or more components together. Because the reaction is very rapid and occurs at the point where the compounds combine, the heat remains localized to the region of the foil. Therefore, if the thermal pulse is provided at room temperature as well, the multilayer foils can be used as localized heat sources to join structural components at room temperature.

A laser is typically used to provide the small thermal pulse to ignite the exothermic reaction. Another method is to ignite the reaction with a spark. These methods usually require special instrumentation in addition to typical electronic assembly equipment.

Piezoelectric material converts force and motion to voltage and charge, or converts voltage and charge to force and motion. Providing sufficient force to piezoelectric material generates a high enough charge on a device to generate a spark. By providing piezoelectric material in a multilayer reactive foil, applying sufficient force directly or indirectly to the piezoelectric material will generate a spark to ignite the exothermic reaction.

FIG. 2 illustrates two sheets 200 of piezoceramic material. To create voltage or charge, a mechanical stress is applied to a sheet of piezoceramic material. The stress results in a voltage generated that tries to return the sheet to its original shape. In the first piezoceramic sheet 205, a force 210 (Fᵢₙ) is applied in a direction normal to the sheet (parallel to the direction 215 of polarization (P)) to reduce the thickness T. The change in thickness ΔTᵢₙ results in a voltage 220 (Vₒᵤₜ) that tries to restore the sheet 205 to the original thickness T.

For the second sheet 230, a force 235 is applied in a transverse direction (perpendicular to the direction 240 of polarization (P)) to reduce the length L. The change in length Lᵢₙ results in a voltage 245 (Vₒᵤₜ) that tries to restore the sheet 230 to the original length L. When a piezoceramic sheet is bonded to a structural member, the piezoceramic sheet will generate a charge or voltage when the structural member is stretched or flexed.

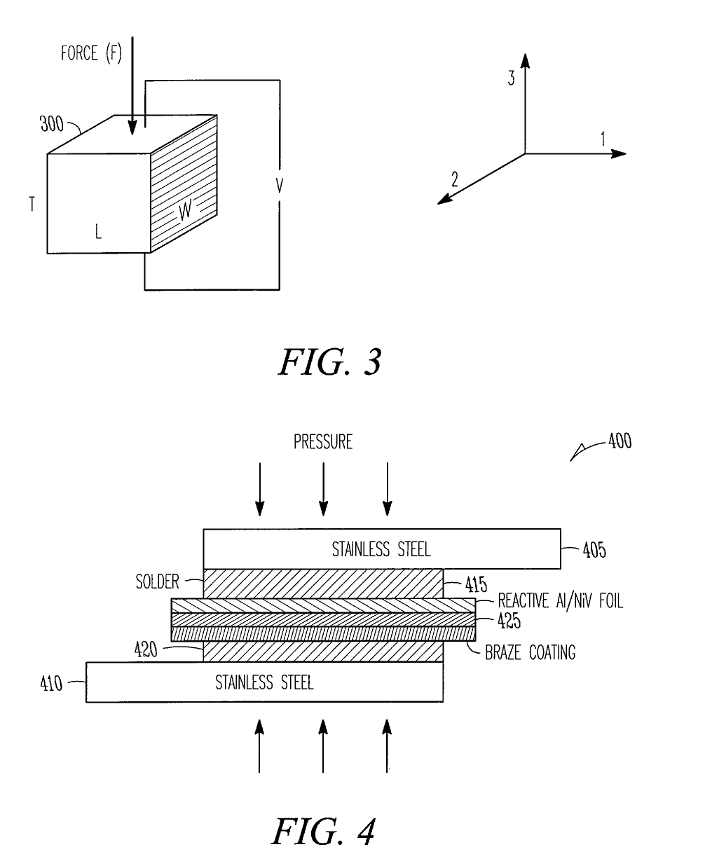

FIG. 3 is a diagram of a piezoceramic sheet 300 reduced to a simplified cubic shape in order to estimate a force required to generate a given voltage. The voltage V generated by a force F that causes a mechanical stress is governed by the equation

$$\frac{V}{T} = \frac{F \times {g}_{33}}{L \times W} , \qquad ( 1 )$$

where T is the thickness, L is the length, W is the width, and g₃₃ is a direct voltage constant for the piezoceramic material. The constant g₃₃ relates a short circuit charge density to an applied stress. The units of g are volt-meters per Newton of force or Vm/N. The first “3” indicates that electrodes to detect the voltage are applied perpendicular to the axis 3 in the FIG., and the second “3” indicates that the applied stress is in the direction of axis 3.

If T=W=L=10 μm, and g₃₃=20×10⁻³ Vm/N, then a generated voltage for a given force F is

$$\begin{matrix}V = \frac{F \times {g}_{33} \times T}{L \times W} \\ = \frac{F \times 20 \times {10}^{- 3} \times {10}^{- 5}}{{10}^{- 5} \times {10}^{- 5}} \\ = F \times 2000 ( \frac{V}{N} ) .\end{matrix} \qquad ( 2 )$$

If one Newton (1N) of force is applied to the 10 μm piezoceramic cube, 2000 volts will be generated. A typical diameter of a particle in commercial piezoelectric powder is less then 1 μm. This means that for such a particle, more than 20,000 volts will be generated for a Newton of force; enough voltage to generate an instantaneous spark.

FIG. 4 illustrates an embodiment of portions of an electronic assembly 400. The assembly 400 includes a first contact 405 of a first electronic device and a second contact 410 of a second electronic device. Typically, contacts of electronic devices include stainless steel. A layer of solder 415, 420 adjoins each of the contacts 405, 410. Between the layers of solder is a multilayered reactive foil preform 425. The stack of solder layers 415, 420 and the multilayered reactive foil preform 425 includes ceramic particles, so that applying pressure to either contact 405, 410 or both contacts results in a spark that propagates the exothermic reaction. The exothermic reaction melts the solder to reflow the solder and form a bond between the contacts. Because the heat of the exothermic reaction remains localized to the solder, a room temperature bond is formed enabling use of the solder with temperature-sensitive components.

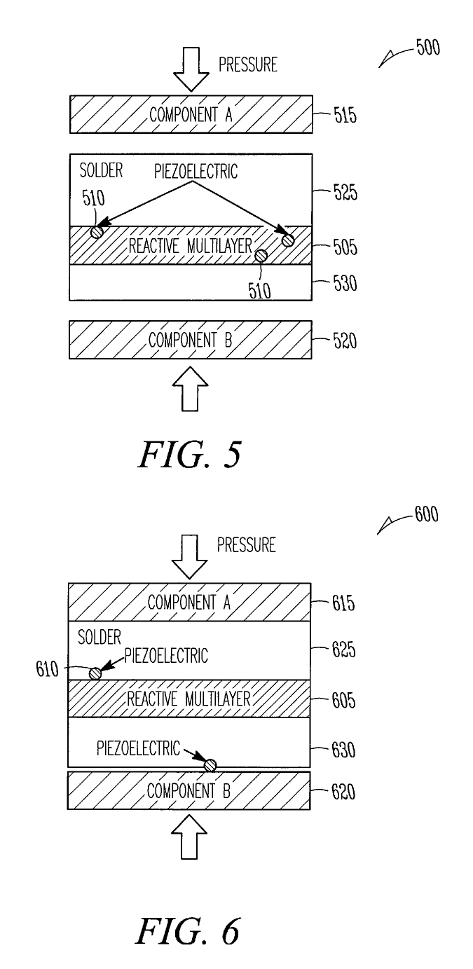

FIG. 5 illustrates a representation of an embodiment of an apparatus 500 that includes a multilayered reactive foil preform 505. The multilayered reactive foil preform 505 includes alternating layers of first and second materials deposited on foils. In some examples, the individual foils have thicknesses between 10 microns and 100 microns. The materials deposited on the foils react with one another in an exothermic and self-propagating reaction. The multilayered reactive foil preform 505 also includes piezoelectric ceramic particles 510 to provide an electrical stimulus when pressure is applied, directly or indirectly, to the particles. The pressure causes a stress in the particles which causes a voltage high enough to cause a spark that activates the exothermic reaction.

In the embodiment of the multilayered reactive foil preform 505 shown, the piezoelectric ceramic particles 510 are distributed within the multilayered reactive foil preform 505. FIG. 5 also includes a representation of contacts of two electronic components; component A 515 and component B 520. In an illustrative example, component A 515 is a packaged electronic device and component B 520 is a motherboard. Solder layers 525 and 530 are provided adjoining component A 515 and component B 520. Pressure is applied to component A 515, or to component B 520, or to both component A 515 and component B 520 to generate a spark to ignite the exothermic chemical reaction caused when the materials in the foils combine. In another illustrative example, a single interconnect bump is formed from the stack of solder layers 525 and 530 and the multilayered reactive foil preform 505. The interconnect bump is one of multiple, similar interconnect bumps extending between a packaged IC and another board.

FIG. 6 illustrates a representation of an embodiment of an apparatus 600 that includes a multilayered reactive foil preform 605 and ceramic particles 610. In the embodiment shown, the ceramic particles are distributed in one or more solder layers 625, 630. Pressure is applied to one or more of the components 615, 620 to generate a spark to ignite the exothermic reaction.

The apparatuses in FIGS. 5 and 6 can be made with existing pick and place machines, making special instrumentation unnecessary. In an example, component A with a layer of solder adjoining the contact is one unit of an assembly, component B with a layer of solder adjoining the contact is a second unit of an assembly, and a multilayered reactive foil preform is a third unit of the assembly. In another example, component A is a first unit of an assembly, component B is a second unit of an assembly, and a multilayered reactive foil preform is a third unit of the assembly and the multilayered reactive foil preform includes a layer of solder on at least one surface of the multilayered reactive foil preform.

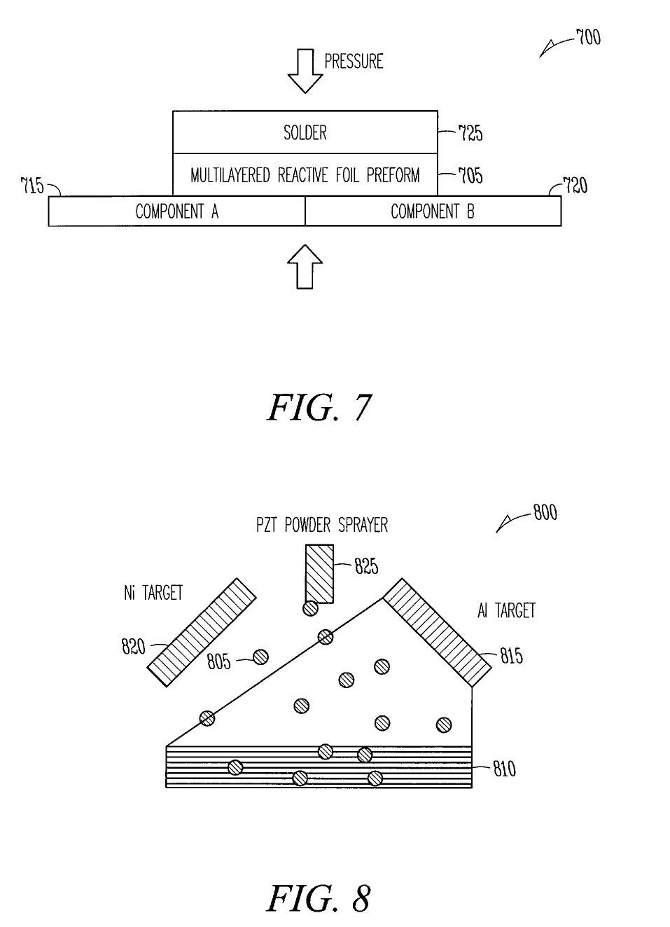

The embodiments of assemblies and apparatuses in FIGS. 4, 5, and 6 show a multilayered reactive foil preform between portions of components, but other adjoining arrangements are possible. For example, FIG. 7 shows an electronic assembly 700 where the first and second contacts 715, 720 are placed adjacent to each other. A multilayered reactive foil preform 705 is placed on top of the contacts 715, 720. At least one solder layer 725 is included. The example shows the solder layer 725 positioned above the multilayered reactive foil preform 705. The solder layer 725 may also be placed between the contacts 715, 720 and the multilayered reactive foil preform 705, or a first solder layer 725 may be positioned above the multilayered reactive foil preform 705 and a second solder layer may be positioned between the contacts 715, 720 and the multilayered reactive foil preform 705. The piezoelectric ceramic particles are not shown, but may be included in either the multilayered reactive foil preform 705 or one or more solder layers 725.

FIG. 8 is a block diagram representing a manufacturing process 800 to make multilayered reactive foil preforms. In one embodiment of the process 800, piezoelectric ceramic particles 805 in the form of a powder may be sprayed during the fabrication of the reactive foil layers 810. The reactive multilayer foils can be fabricated by sputtering to deposit alternating layers of reactive materials, such as aluminum 815 and nickel 820, on the reactive foil layers 810. Other possible material layer pairs include aluminum and zirconium, silicon and nickel, and silicon and niobium.

If the piezoelectric ceramic particles are to be included in the reactive foil layers 810, the piezoelectric powder 825 can be sprayed onto the reactive foil layers 810 during the sputtering process. In some embodiments, the piezoelectric ceramic particles of the piezoelectric powder 825 have a diameter less then one micrometer (1 μm). FIG. 8 shows a representation of the piezoelectric powder 825 being sprayed onto the reactive foil layers 810 during a sputter deposition of aluminum 815. In some embodiments, after the multilayered reactive preform with the piezoelectric ceramic particles is fabricated, the preform is inserted into a molten solder bath to provide a layer of solder on at least one surface of the preform. In some embodiments, a solder layer is not added to the multilayered reactive preform with the embedded piezoelectric ceramic particles.

In some embodiments, the solder includes eutectic tin-lead (Sn—Pb) solder. In some embodiments, the solder includes tin-silver-copper (Sn—Ag—Cu) solder. After preforms are fabricated, they are picked and placed adjoining two or more components, and the components include contacts with an adequate coating or solder deposition layer on one or more contact surfaces for subsequent bonding using an exothermic reaction.

If the piezoelectric ceramic particles are to be included in one or more solder layers, the piezoelectric ceramic particles may be mixed into a melted solder bath in some embodiments. The multilayered reactive preform can then be inserted into a molten solder bath to provide a layer of solder on at least one surface of the preform. According to further embodiments, the molten solder which includes the piezoelectric ceramic particles is then added as a coating to one or more contact surfaces. In some embodiments, the piezoelectric ceramic particles are deposited onto one or more contact surfaces together with the solder.

The apparatuses described above can be included in an electronic assembly where it is desirable to include a metallurgical bond at room temperature between two contacts. The bond is formed by reflowing the solder using an electrical stimulus provided by piezoelectric ceramic particles that propagates an exothermic reaction. The reflow begins when an exothermic reaction starts in the multilayer reactive foil preform by applying pressure to cause the piezoelectric ceramic particles to provide the electrical stimulus to the preform.

In some embodiments, such a bond is formed in an assembly between a contact of a motherboard and contact of a packaged electronic device. In some embodiments, the bond is formed between a contact of an electronic device, such as an integrated circuit chip (IC), and a contact of a multi-chip module (MCM) substrate. In some embodiments, the bond is formed between a contact of an optoelectronic device and a contact of a printed circuit board (PCB). In some examples, the bond is formed between a contact of an IC and a contact of a heat spreader. A heat spreader, or thermal spreader, is a device bonded to an IC or die to dissipate concentrated areas of heat that may occur when the IC is operating. A heat spreader is bonded to an IC to dissipate heat into the surrounding ambient air. In some examples, the heat spreader includes copper, and the metallurgical bond is formed between a silicon contact of the IC and a copper contact of the heat spreader.

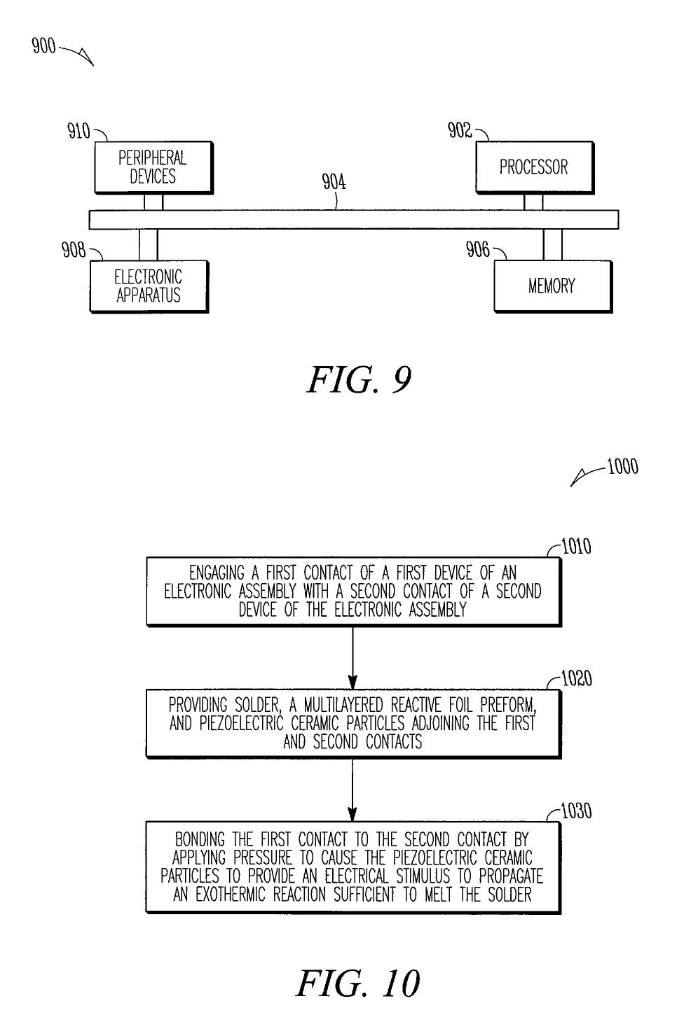

FIG. 9 is a block diagram of an electronic system 900. The system 900 includes a processor 902 and a memory 906. The term processor 902 includes a digital signal processor, ASIC, microprocessor, or other type of processor operating on a mobile, portable, or stationary computer system, such as a personal computer, server or other electronic system 900. In some embodiments, the memory 906 includes a dynamic random access memory (DRAM). In some embodiments, the memory 906 includes a static random access memory (SRAM). In some embodiments, the memory 906 includes flash memory.

Processor 902 and/or memory 906 include a bond formed as described herein. According to some embodiments, the processor 902 and memory 906 are included on a motherboard. In some embodiments, processor 902 is packaged with a heat spreader. System 900 also includes an electronic apparatus 908, and a bus 904, where bus 904 may provide electrical conductivity and data transmission between processor 902 and electronic apparatus 908, and between processor 902 and memory 906. Bus 904 may include an address, a data bus, and a control bus, each independently configured. Bus 904 also uses common conductive lines for providing address, data, and/or control, the use of which may be regulated by processor 902. FIG. 9 shows the processor 902 in communication with the memory 906 over a bus 904, but in some embodiments the processor 902 may be coupled directly to the memory 906.

In an embodiment, electronic apparatus 908 includes additional memory devices configured similarly to memory 906. An embodiment includes an additional peripheral device or devices 910 coupled to bus 904. Any of processor 902, memory 906, bus 904, electronic apparatus 908, and peripheral device or devices 910 may include a bond formed in accordance with the disclosed embodiments. System 900 may include, but is not limited to, information handling and telecommunication systems, and computers. Peripheral devices 910 may include displays, additional storage memory, or other control devices that may operate in conjunction with processor 902 and/or memory 906.

FIG. 10 is a block diagram of a method 1000 that provides low-temperature metallurgical bonding for interconnecting electronic components. At 1010, a first contact of a first device of an electronic assembly is engaged with a second contact of a second device of the electronic assembly. In some embodiments, one or more of the first and second devices is a temperature sensitive device such as an optoelectronic device. At 1020, solder, a multilayered reactive foil preform, and piezoelectric ceramic particles are provided. The solder, the multilayered reactive foil preform, and piezoelectric ceramic particles adjoin the first and second contacts. In some embodiments, the solder includes eutectic tin-lead solder. In some embodiments, the solder includes eutectic tin-gold solder. In some embodiments, the solder includes eutectic tin-silver solder. In some embodiments, the multilayered reactive foil preform includes alternate layers of materials that release a high amount of exothermic heat in a chemical reaction when combined, and the piezoelectric ceramic particles are provided within the solder. In some embodiments, the piezoelectric ceramic particles are provided within the multilayered reactive foil preform.

According to some embodiments, the solder, the multilayered reactive foil preform, and the piezoelectric ceramic particles adjoin the contacts by being arranged between the first and second contacts. In some embodiments, the multilayered reactive foil preform is arranged between a first solder layer adjoining the first contact and a second solder layer adjoining the second contact. At 1030, the first contact is bonded to the second contact at room temperature by applying pressure to cause the piezoelectric ceramic particles to provide an electrical stimulus to propagate an exothermic reaction sufficient to melt the solder. Typically, the multilayered reactive foil preform is prefabricated before the bonding process and is provided as a subassembly. The pressure is applied at ambient room temperature and the melting causes the solder to reflow. The bond is formed when the solder cools to the ambient room temperature. The pressure is applied directly or indirectly to the piezoelectric ceramic particles. In some embodiments, the pressure is applied to at least one solder layer. In some examples, a solder layer is provided on a top surface of the multilayered reactive foil and a bottom surface of the multilayered reactive foil and pressure is applied to both solder layers. In some examples, pressure is applied to a multilayered reactive foil that contains piezoelectric ceramic particles to start the exothermic reaction.

The methods, systems, and apparatuses described provide metallurgical bonding at room temperature. Because the heat of the exothermic reaction occurs rapidly and in a small area, the heating is localized which allows the bonding to be used with temperature-sensitive electronic devices. This includes those temperature-sensitive devices for which metallurgical bonding is typically not possible.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually, collectively, or both by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own.

What is claimed is:

1. Apparatus comprising:
a multilayered reactive foil preform including one or more alternating layers of first and second materials; and
piezoelectric ceramic particles to provide an electrical stimulus when pressure is applied thereto to activate an exothermic reaction between the first and second materials.

2. The apparatus of claim 1 wherein the piezoelectric ceramic particles are distributed within the multilayered reactive foil preform.

3. The apparatus of claim 2, wherein the piezoelectric ceramic particles are deposited on one or more layers of the foils together with the first and second materials.

4. The apparatus of claim 1, further including solder adjoining at least a first surface of the multilayered reactive foil preform, wherein the piezoelectric ceramic particles are included in the solder.

5. The apparatus of claim 4, wherein the solder includes eutectic solder.

6. The apparatus of claim 1, wherein the first and second materials of the alternating layers include one or more sets of materials from the group of sets consisting of:
a) aluminum and nickel;
b) aluminum and zirconium;
c) silicon and nickel; and
d) silicon and niobium.

7. The apparatus of claim 1, wherein the piezoelectric ceramic particles have a diameter less than one micrometer (1 μm).

8. An electronic assembly comprising:
a first device including at least a first contact;
a second device that includes at least a second contact; and
a metallurgical bond layer including solder between the first contact and the second contact, wherein the solder is reflowed using an electrical stimulus provided by piezoelectric ceramic particles when pressure is applied to activate an exothermic reaction.

9. The electronic assembly of claim 8, wherein the solder is reflowed by applying pressure to cause the piezoelectric ceramic particles to provide the electrical stimulus to a multilayered reactive foil preform.

10. The electronic assembly of claim 9, wherein the piezoelectric ceramic particles are included in the multilayered reactive foil preform before the metallurgical bond layer is formed, and wherein the multilayered reactive foil preform includes the piezoelectric ceramic particles and alternate layers of materials that react with one another in an exothermic reaction.

11. The electronic assembly of claim 9, wherein the piezoelectric ceramic particles are included in one or more solder layers before the solder is reflowed.

12. The electronic assembly of claim 8, wherein the first device is a motherboard and the second device is a packaged electronic device.

13. The electronic assembly of claim 8, wherein the first device includes an integrated circuit chip (IC) and the second device is a heat spreader.

14. The electronic assembly of claim 13, wherein the first contact includes silicon and the second contact includes copper.

15. The electronic assembly of claim 8, wherein the first device includes an electronic device and the second device is a multi-chip module (MCM) substrate.

16. The electronic assembly of claim 8, wherein the first device includes an optoelectronic device and the second device is a printed circuit board (PCB).

17. The electronic assembly of claim 8, wherein the solder includes eutectic solder.

18. A system comprising:
a memory, wherein the memory includes a dynamic random access memory (DRAM) circuit;
a processor in communication with the memory, wherein the processor includes a first contact;
a second device that includes a second contact, wherein the second contact is bonded to the first contact; and
a metallurgical bond layer including solder between the first contact and the second contact, wherein the solder is reflowed using an electrical stimulus provided by piezoelectric ceramic particles when pressure is applied to activate an exothermic reaction.

19. The system of claim 18, wherein the second device is a motherboard.

20. The system of claim 18, wherein the second device is a heat spreader.

21. A method comprising:
engaging a first contact of a first device of an electronic assembly with a second contact of a second device of the electronic assembly;
providing solder, a multilayered reactive foil preform, and piezoelectric ceramic particles adjoining the first contact and the second contact; and
bonding the first contact to the second contact by applying pressure to cause the piezoelectric ceramic particles to provide an electrical stimulus to activate an exothermnic reaction that reflows the solder.

22. The method of claim 21, wherein providing includes:
providing a prefabricated multilayered reactive foil preform including alternate layers of materials that react with one another in an exothermic reaction; and
providing the piezoelectric ceramic particles within the solder.

23. The method of claim 21, wherein providing includes:
providing a prefabricated multilayered reactive foil preform including alternate layers of materials that react with one another in an exothermic reaction; and
providing piezoelectric ceramic particles within the multilayered reactive foil preform.

24. The method of claim 21, wherein providing includes providing the solder, the multilayered reactive foil preform, and the piezoelectric ceramic particles between the first contact and the second contact.

25. The method of claim 24, wherein providing includes providing the multilayered reactive foil preform between a first solder layer adjoining the first contact and a second solder layer adjoining the second contact.

26. The method of claim 25, wherein applying pressure includes applying pressure at room temperature to at least one of the first and second solder layers.
